(19) United States
(12) Patent Application Publication
(10) Pub. No.: US 2009/0295698 A1
(43) Pub. Date: Dec. 3, 2009

(54) DISPLAY APPARATUS

(75) Inventor: Tomomi KAMIO, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/465,019

(22) Filed: May 13, 2009

(30) Foreign Application Priority Data
May 30, 2008 (JP) 2008-142995

(51) Int. Cl. G09G 3/36

(52) U.S. Cl. 345/92; 345/87

(57) ABSTRACT

A display apparatus having a plurality of scanning lines and a plurality of signal lines is provided. A plurality of first pixels are arranged between first and second scanning lines adjacent to each other, and arranged near at least some of the signal lines. A plurality of second pixels are arranged, some on one side of the signal line arranged near the first pixels, and the others on the other side of the signal. A plurality of first switching elements are connected to the first pixels, to the signal line near the first pixels and to the first scanning line. A plurality of second switching elements are connected to the second pixels and to the signal line near the first pixels. A plurality of third switching elements are connected to the second switching elements, to the first scanning line and to the second scanning line.

### CROSS-REFERENCE TO RELATED APPLICATIONS

This application is based upon and claims the benefit of priority from prior Japanese Patent Application No. 2008-142995, filed May 30, 2008, the entire contents of which are incorporated herein by reference.

### BACKGROUND OF THE INVENTION

1. Field of the Invention

The present invention relates to an active-matrix display apparatus.

2. Description of the Related Art

Active-matrix displays are used in liquid crystal display apparatuses and the like. The active-matrix display has scanning lines, signal lines, arid pixels. The scanning lines extend parallel, in the row direction of the display unit. The signal lines parallel, in the column direction of the display unit. The pixels are connected at the intersections of the scanning lines and signal lines. A voltage of a prescribed value is applied to the pixels selected, thereby displaying an image. In the conventional display, each pixel is connected to one signal line and one scanning line. Therefore, the source driver for driving the signal lines must have as many output terminals as the signal lines, and the gate driver for driving the scanning lines must have as many output terminals as the scanning lines.

A technique for reducing the number of signal lines used in the active-matrix display is described in, for example, Jpn. Pat. Appln. KOKAI Publication No. 2006-201315. This technique resides in connecting two TFTs to the ends of each signal line. To these two TFTs, first and second scanning lines are connected, respectively. Further, the display has an image output circuit and first and second switching elements. The image output circuit is configured to apply image signals for four pixels. In this configuration, the first and second switching elements switch the image signals supplied through two signal lines. Hence, one signal line can be used in common for two TFTs, i.e., two pixels.

The technique described in Jpn. Pat. Appln. KOKAI Publication No. 2006-201315 can indeed reduce the number of signal lines to half the number required in the conventional display. However, twice as many scanning lines as hitherto used are needed.

### BRIEF SUMMARY OF THE INVENTION

An object of this invention is to provide a display apparatus in which the number of signal lines can be reduced without increasing the number of scanning lines.

A display apparatus according to one aspect of the invention comprises:

a plurality of scanning lines;

a plurality of signal lines arranged, intersecting at right angles with the scanning lines;

a plurality of first pixels arranged between first and second scanning lines adjacent to each other, and arranged near at least some of the signal lines;

a plurality of second pixels arranged, some on one side of the signal line arranged near the first pixels, and the others on the other side of the signal line;

a plurality of first switching elements connected to the first pixels, to the signal line near the first pixels and to the first scanning line;

a plurality of second switching elements connected to the second pixels and to the signal line near the first pixels; and

a plurality of third switching elements connected to the second switching elements, to the first scanning line and to the second scanning line.

A display apparatus according to another aspect of the invention comprises:

a first pixel and a second pixel arranged adjacent to each other, respectively on one side of a signal line and the other side therefore;

a first scanning line and second scanning line arranged, respectively on one side of the first and second pixels and on the other side thereof;

a first thin film transistor having a gate electrode connected to the first scanning line, and having a source electrode and a drain electrode, one of which is connected to the first signal line and the other of which is connected to the first pixel;

a second thin film transistor having a source electrode and a drain electrode, one of which is connected to the signal line and the other of which is connected to the second pixel; and

a third thin film transistor having a gate electrode connected to the second scanning line, and having a source electrode and a drain electrode, one of which is connected to the first scanning line and the other of which is connected to the gate electrode of the second thin film transistor.

A display apparatus according to another aspect of the invention comprises:

a first pixel and a second pixel arranged adjacent to each other, respectively on one side of a first signal line and the other side therefore;

a first scanning line and second scanning line arranged, respectively on one side of the first and second pixels and the other side thereof;

a first thin film transistor having a gate electrode connected to the first scanning line, and having a source electrode and a drain electrode, one of which is connected to the first scanning line and the other of which is connected to the first pixel;

a second thin film transistor having a source electrode and a drain electrode, one of which is connected to the second signal line; and

a third thin film transistor having a gate electrode connected to the first scanning line, and having a source electrode and a drain electrode, one of which is connected to the first signal line and the other of which is connected to the other of the source and drain electrodes of the second thin film transistor;

a third pixel arranged near the first pixel and on a side other than the side of the first pixel; and

a fourth thin film transistor having a gate electrode connected to the first scanning line, and having a source electrode and a drain electrode, one of which is connected to the second signal line and the other of which is connected to the third pixel.

A display apparatus according to another aspect of the invention comprises:

a first pixel and a second pixel arranged adjacent to each other, respectively on one side of a signal line and the other side therefore;

a first scanning line and a second scanning line arranged, respectively on one side of the first and second pixels and on the other side thereof;

a first thin film transistor having a gate electrode connected to the first scanning line, and having a source electrode and a drain electrode, one of which is connected to the signal line and the other of which is connected to the first pixel;

a second thin film transistor having a gate electrode connected to the second scanning line, and having a source electrode and a drain electrode, one of which is connected to the second pixel; and

a third thin film transistor having a gate electrode connected to the first scanning line, and having a source electrode and a drain electrode, one of which is connected to the signal line and the other of which is connected to the other of the source and drain electrodes of the second thin film transistor.

A display apparatus according to another aspect of the invention has a plurality of pixel columns corresponding to green a component, a plurality of pixel columns corresponding to a blue component, and a plurality of pixel columns corresponding to a red component. The green component, blue component and red component are alternately arranged in rows in the order mentioned, or the green component, red component and blue component are alternately arranged in rows in the order mentioned. This display apparatus comprises:

first signal lines electrically connected to the pixel columns corresponding to a green component, respectively; and

second signal lines, each electrically connected to two adjacent pixel columns one of which corresponds to a red component and the other of which corresponds to a blue component.

The present invention can provide display apparatuses in which the number of signal lines can be reduced without increasing the number of scanning lines.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the overall configuration of a liquid crystal display which is an example of a display apparatus according to a first embodiment of the present invention;

FIG. 2 is a diagram showing the pixel-connection configuration used in the first embodiment;

FIG. 3 is a diagram showing an equivalent circuit of one of the pixels that are provided in the display unit of the display;

FIG. 4 is a timing chart showing how the liquid crystal display according to the first embodiment operates;

FIG. 5 is a diagram showing a modified pixel-connection configuration that may be used in the first embodiment;

FIG. 6 is a timing chart explaining how a modified liquid crystal display according to the first embodiment operates;

FIG. 7 is a diagram showing the pixel-connection configuration used in a second embodiment of the present invention;

FIG. 8 is a timing chart explaining how a liquid crystal display according to the second embodiment operates;

FIG. 9 is a diagram showing a modified pixel-connection configuration that may be used in the second embodiment; and

FIG. 10 is a timing chart explaining how a modified liquid crystal display according to the second embodiment operates.

### DETAILED DESCRIPTION OF THE INVENTION

Embodiments of the present invention will be described with reference to the accompanying drawings.

### First Embodiment

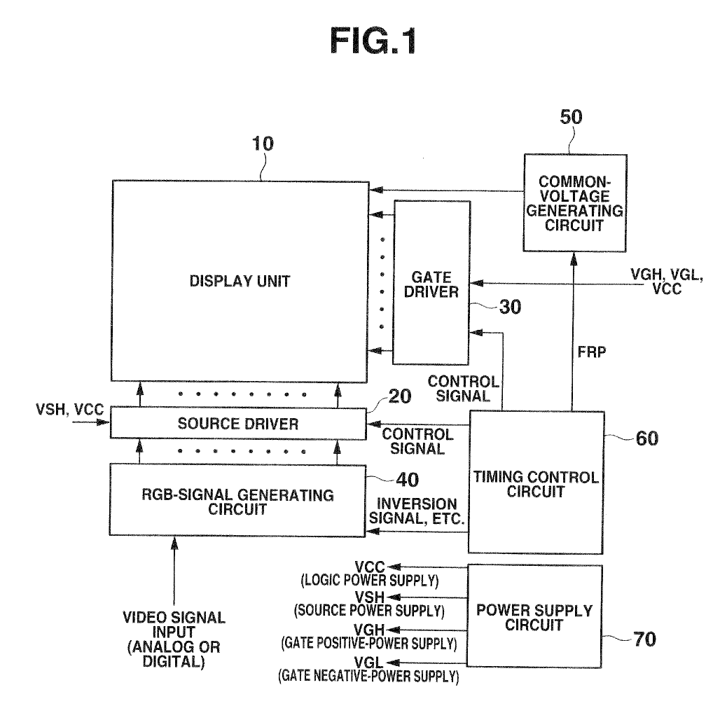

FIG. 1 is a diagram showing the overall configuration of a liquid crystal display that is an example of the display apparatus according to a first embodiment of this invention. As shown in FIG. 1, the liquid crystal display comprises a display unit 10, a source driver (signal-line driver circuit) 20, a gate driver (scanning-line driver circuit) 30, an RGB-signal generating circuit 40, a common-voltage generating circuit 50, a timing control circuit 60, and a power supply circuit 70.

The display unit 10 comprises a plurality of scanning lines, a plurality of signal lines, and a plurality of pixels. Each pixel is connected to a scanning line and a signal line.

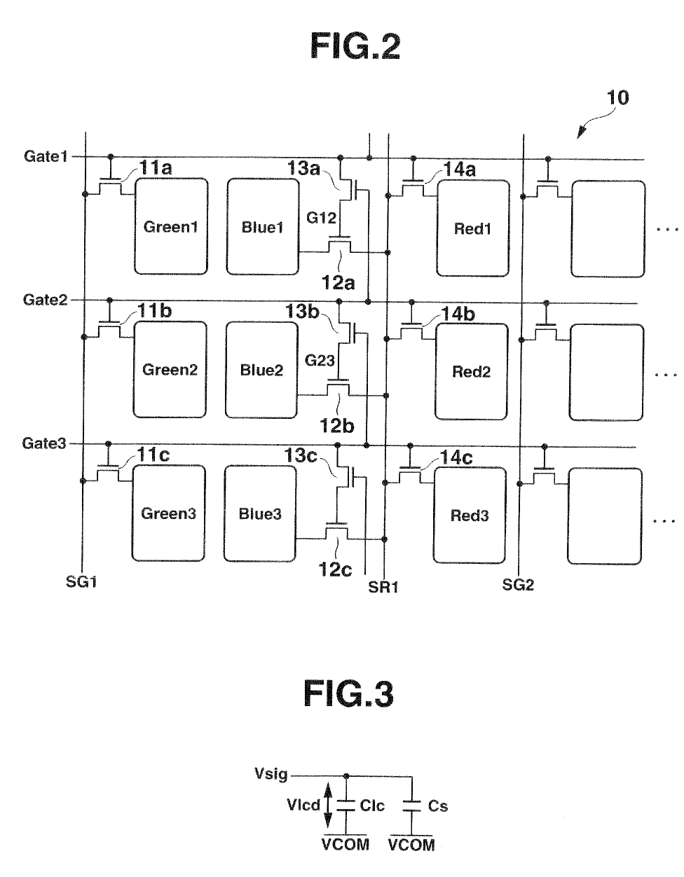

FIG. 2 is a diagram showing the pixel-connection configuration used in the first embodiment. Note that FIG. 2 shows only nine of the pixels provided in the display unit 10. That is, the display unit 10 has other groups each having a connection configuration similar to the configuration of FIG. 2. The display unit 10 shown in FIG. 2 is a color display. Hence, a color filter, i.e., red filer, green filter or blue filter, is provided for each pixel. In FIG. 2, “GreenN” (N=1, 2, 3) indicates a pixel that corresponds to green (i.e., pixel having a green filter), “RedN” (N=1, 2, 3) indicates a pixel that corresponds to red (i.e., pixel having a red filter), and “BlueN” (N=1, 2, 3) indicates a pixel that corresponds to blue (i.e., pixel having a blue filter).

As shown in FIG. 2, scanning lines Gate1, Gate2, and Gate3 are arranged, each intersecting at right angles with signal lines SG1, SR1, and SG2.

Near the intersections of the scanning lines Gate1, Gate2 and Gate3 and the signal line SG1, pixels Green1, Green2 and Green3 are arranged.

The pixels Green1, Green2, and Green3 (i.e., third pixels) are connected to the scanning lines Gate1, Gate2, and Gate3 and the signal line SG1 by thin-film transistors (TFTs) 11a, 11b, and 11c (i.e., fourth switching elements), respectively. More precisely, the pixels Green1, Green2, and Green3 are connected to the drain electrodes D (or source electrodes S) of the TFTs 11a, 11b, and 11c, respectively. Further, the Source electrodes S (or the drain electrodes D) of the TFTs 11a, 11b, and 11c are connected to the signal line SG1. The gate electrodes G of the TFTs 11a, 11b, and 11c are connected to the scanning lines Gate1, Gate2, and Gate3, respectively.

Further, near the intersections of the scanning lines Gate1, Gate2 and Gate3 and the signal line SR1, pixels Red1, Red2 and Red3 and pixels Blue1, Blue2 and Blue3 are arranged. The pixels Red1, Red2 and Red3 are arranged on one side of the signal line SR1, while the pixels Blue1, Blue2 and Blue3 are arranged on the other side of the signal line SR1.

The pixels Blue1, Blue2, and Blue3 (i.e., second pixels) are connected to the scanning lines Gate1, Gate2 and Gate3 and the signal line SR1, respectively, by TFTs 12a, 12b, and 12c (i.e., second switching elements) and TFTs 13a, 13b and 13c (i.e., third switching elements). More precisely, the pixels Blue1, Blue2, and Blue3 are connected to the drain electrodes (or source electrodes) of the TFTs 12a, 12b, and 12c, respectively. Further, the source electrodes (or drain electrodes) of the TFTs 12a, 12b, and 12c are connected to the signal line SR1. The gate electrodes of the TFTs 12a, 12b and 12c are connected to the drain electrodes (or source electrodes) of TFTs 13a, 13b, and 13c, respectively. The source electrodes (or drain electrodes) of the TFTs 13a, 13b and 13c are connected, each to the upper (i.e., first scanning line) of the two scanning lines, between which a row of pixels extends. The gate electrodes of the TFTs 13a, 13b and 13c are connected, each to the lower (i.e., second scanning line) of the two scanning lines, between which a row of pixels extends.

The pixels Red1, Red2, and Red3 (i.e., first pixels) are connected to the scanning lines Gate1, Gate2, and Gate3 and the signal line SR1 via the TFTs 14a, 14b and 14c. More precisely, the pixels Red1, Red2, and Red3 are connected to the drain electrodes (or source electrodes) of TFTs 14a, 14b, and 14c (i.e., first switching elements), respectively. The source electrodes (or the drain electrodes) of the TFTs 14a, 14b and 14c are connected to the signal line SR1. The gate electrodes of the TFTs 14a, 14c and 14b are connected to the scanning lines Gate1, Gate2, and Gate3, respectively.

The gate driver 30 supplies a scan signal to the scanning lines Gate1, Gate2 and Gate3. To the signal line SG1, the source driver 30 supplies a gradation signal that corresponds to indication in green. Further, the source driver 20 supplies gradation signals that pertain to red display and blue display, respectively, in a time sharing fashion.

Thus, color filters are arranged in the form of stripes in the display unit 10. Each stripe is a column of pixels for the same color component (the column extending along a signal line). Further, three pixels corresponding to red, green and blue components, respectively, are repeatedly arranged in the row direction (i.e., along a scanning line). Any two adjacent pixels corresponding to red and blue components, respectively, are connected to the same signal line. Any pixel that corresponds to a green component is connected to a signal line different from the signal line to which the pixels corresponding to red and blue components are connected.

In the embodiment of FIG. 2, the number of signal lines can be reduced to two-thirds (⅔) of the number of pixels forming one row.

FIG. 3 is a diagram showing an equivalent circuit of one of the pixels that are provided in the display unit 10. As shown in FIG. 3, each pixel has a pixel capacitor Clc and a compensation capacitor Cc. The pixel capacitor Clc comprises two parallel electrodes and a liquid crystal layer. The pixel capacitor Clc is connected to a TFT (TFT 11, 12 or 14). The liquid crystal layer is interposed between the parallel electrodes. The pixel capacitor Clc and compensation capacitor Cc are connected to the same signal line and can receive a common signal VCOM. In the pixel thus configured, a gradation signal Vsig is supplied to the pixel capacitor Clc via the TFT. When the gradation signal Vsig is supplied to the pixel capacitor Clc, the orientation of the liquid crystal changes in accordance with the voltage difference (i.e., pixel voltage) Vlcd between the gradation signal Vsig and the common signal VCOM. As a result, the transmission of the light emitted from a light source (not shown) provided on the back of the pixel (FIG. 3) changes, displaying an image.

The signal lines shown in FIG. 2 are connected to the source driver 20. The source driver 20 acquires display data items corresponding to R, G and B components, from the RGB-signal generating circuit 40, in response to the horizontal control signals (i.e., clock signal, start signal, latch signal, etc.) output from the timing control circuit 60. The source driver 20 supplies gradation signals corresponding to the display data items acquired, to the signal lines of the display unit 10.

The scanning lines shown in FIG. 2 are connected to the gate driver 30. The source driver 30 receives vertical control signals from the output from the timing control circuit 60 and outputs scan signals to the scanning lines of the display unit 10, to turn on or off the TFTs connected to each scanning line.

The RGB-signal generating circuit 40 generates display data items corresponding to R, G and B colors, from the video signal (either analog or digital) supplied from an apparatus outside the liquid crystal display apparatus. The display data items, thus generated, are output to the source driver 20. The RGB-signal generating circuit 40 receives from the timing control circuit 60 a polarity inversion control signal FRP in each prescribed period (e.g., one-frame period or one-field period). Thus, every time the RGB-signal generating circuit 40 receives a polarity inversion control signal, it inverts the bit values of the display data input to the source driver 20. Because the bit values of the display data are inverted, the polarity of the gradation signal supplied to each pixel is also inverted. The polarity of the gradation signal remains inverted for a prescribed period. The pixels can therefore be driven with an alternating current.

The common-voltage generating circuit 50 receives the polarity inversion control signal from the timing control circuit 60. In response to the polarity inversion control signal, the common-voltage generating circuit 50 generates a common signal VCOM, whose polarity is inverted for a prescribed period (e.g., one-frame period or one-field period). The common signal VCOM is supplied to the pixels.

The timing control circuit 60 generates various control signals, such as a vertical control signal, a horizontal control signal and a polarity inversion control signal. The polarity inversion control signal is output to the RGB-signal generating circuit 40 and common-voltage generating circuit 50. The vertical control signal is output to the gate driver 30. The horizontal control signal is output to the source driver 20.

The power supply circuit 70 generates power-supply voltages VGH and VGL to generate scan signals. The power-supply voltages VGH and VGL are applied to the gate driver 30. The power supply circuit 70 generates a power supply voltage VSH, too. The power supply voltage VSH is applied to the source driver 20. Further, the power supply circuit 70 generates a logic power-supply voltage VCC, which is applied to the source driver 20 and gate driver 30.

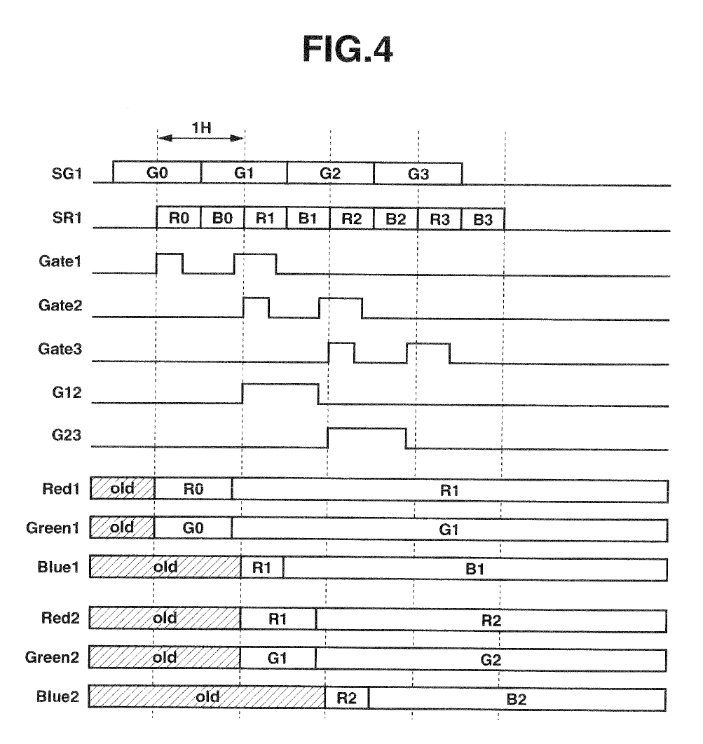

How the liquid crystal display apparatus according to this embodiment operates will be explained. FIG. 4 is a timing chart showing how the liquid crystal display according to the embodiment operates. FIG. 4, shows a gradation signal supplied to signal line SG1, a gradation signal supplied to signal line SR1, a scan signal supplied to scanning line Gate1, a scan signal supplied to scanning line Gate2, a scan signal supplied to scanning line Gate3, the gate potential G12 of TFT 12a, the gate potential G23 of TFT 12b, the display state of pixel Red1, the display state of pixel Green1, the display state of pixel Blue1, the display state of pixel Red2, the display state of pixel Green2, and the display state of pixel Blue2, from top to bottom in the order mentioned.

In this embodiment, the display data item pertaining to the green display is input to the source driver 20, for half (½) the horizontal period before the display data items pertaining to the red display and blue display, respectively, are input. The display data items pertaining to the red display and the blue display are alternately input, each for half (½ ) the horizontal period. Thus, as shown in FIG. 4, the gradation signals R0, B, R1, B1, R2, B2, . . . pertaining to the red and blue display are supplied to the signal line SR1, for half (½ ) the horizontal period after the gradation signals G0, G0, G2, . . . pertaining to the green display have been supplied to the signal line SG1.

How the pixels Green1, Blue1 and Red1 connected to the scanning line Gate1 and the pixels Green2, Blue2 and Red2 connected to the scanning line Gate2 are controlled to perform display will be explained. Any other pixels are controlled in the same way as will be explained below. Note that signals old, R0, G0 and B0, which are shown in FIG. 4, pertain to the display performed for the rows preceding the row for which the display is performed by using signals old, R0, G0 and B0.

To perform display by using the pixels Green1, Blue1 and Red1, the scan signals on the scanning lines Gate1 and Gate2 are maintained High for prescribed periods, respectively. The period for which the scan signal on the scanning line Gate1 remains High is longer than the period for which the scan signal on the scanning line Gate2 remains High. In the case of FIG. 4, the period for which the scan signal on the scanning line Gate1 remains High is half (½) the horizontal period, and the period for which the scan signal on the scanning line Gate2 remains High is shorter than half (½) the horizontal period.

When the scan signal on the scanning line Gate1 is set to High, both TFT 11a and TFT 14a are turned on. The gradation signal G1 supplied to the signal line SG1 is thereby written in the pixel Green1. The pixel Green1 therefore starts performing display in response to the gradation signal G1. At the same time, the gradation signal R1 supplied to the signal line SR1 is written in the pixel Red1. The pixel Red1 therefore starts performing display in response to the gradation signal R1.

When the scan signal on the scanning line Gate2 is set to High, TFT 11b, TFT 14a, TFT 13a and TFT 12a are turned on. The gradation signal G1 supplied to the signal line SG1 is thereby written in the pixel Green2. The pixel Green2 therefore starts performing display in response to the gradation signal G1. The gradation signal R1 supplied to the signal line SR1 is written in the pixel Red2. The pixel Red2 therefore starts performing display in response to the gradation signal R1.

After the scan signal on the scanning line Gate2 has fallen to Low, the pixel voltages Vlcd generated in the pixels Green2 and Red2, respectively, are held in the compensation capacitors Cs that the pixels Green2 and Red2 have, until the scan signal on the scanning line Gate2 is set to High again. Since the scan signal on the scanning line Gate2 remains Low while the scanning line Gate1 remains High, the gate potential G21 of TFT 12a is held at High level of the scan signal Gate1 until the scan signal on the scanning line Gate2 is set to High again. While TFT 12a remains on, the gradation signal B1 on the signal line SR1 is written in the pixel Blue1. The pixel Blue1 therefore starts performing display in response to the gradation signal B1.

After the scan signal on the scanning line Gate1 has fallen to Low, the pixel voltages Vlcd generated in the pixels Green1 and Red1 are held in the compensation capacitors Cs that the pixels Green1 and Red1 have, until the scan signal on the scanning line Gate1 is set to High again. Thus, the pixels P1, G1 and B1 perform appropriate gradation display based on the video signal.

To cause the pixels Green2, Blue2 and Red2 to perform display in the next horizontal period, the scan signal on the scanning line Gate2 and the scan signal on the scanning line Gate3 are maintained High for the prescribed period. In the case of FIG. 4, the scan signal on the scanning line Gate2 remains High for half (½) the horizontal period, and the scan signal on the scanning line Gate3 remains High for a period shorter than half (½) the horizontal period.

When the scan signal on the scanning line Gate2 is set to High, TFT 11b, TFT 14b and TFT 12a are turned on as described above. The gradation signal G2 supplied to the signal line SG1 is thereby written anew in the pixel Green2. The pixel Green2 performs display in response to the gradation signal G2. Further, the gradation signal R2 supplied to the signal line SR1 is written anew in the pixel Red2. The pixel Red2 performs display in response to the gradation signal R2. Moreover, since TFT 12a is turned on while the scanning line Gate1 remains Low, the pixel voltage Vlcd generated in the pixel Blue1 is held in the compensation capacitor Cs.

When the scan signal on the scanning line Gate3 is set to High, TFT 11c, TFT 14c, TFT 13b and TFT 12b are turned on. As a result, the gradation signal G2 supplied to the signal line SG1 is written in the pixel Green3. The pixel Green3 performs display in response to the gradation signal G2. Further, the gradation signal R2 supplied to the signal line SR1 is written in the pixel Red3. The pixel Red3 performs display in response to the gradation signal R2.

After the scan signal on the scanning line Gate3 has fallen to Low, the pixel voltages Vlcd generated in the pixels Green3 and Red3 are held in the compensation capacitors Cs that the pixels Green3 and Red3 have, respectively, until the scan signal on the scanning line Gate3 is set to High again. Moreover, until the scan signal on the scanning line Gate3 is set to High again, the gate potential G23 of TFT 12b is held at the High level of the scan signal Gate2. Since TFT 12b remains on, the gradation signal B2 supplied to the signal line SR1 is written in the pixel Blue2. The pixel Blue 2 therefore starts performing display in response to the gradation signal B1.

After the scan signal on the scanning line Gate2 has fallen to Low, the pixel voltages Vlcd generated in the pixels Green2 and Red2 are held by the compensation capacitors Cs that these pixels have, respectively, until the scan signal on the scanning line Gate2 is set to High again. Thus, the pixels R2, G2 and B2 perform appropriate gradation display based on the video signal.

The same control as described above is performed on the rows following the scanning line Gate3. The pixels of these rows also perform appropriate gradation display based on the video signal.

As has been explained, the signal line used for any pixel is used for another pixel adjacent to the pixel, by using a TFT, in the first embodiment. Hence, the number signal lines and that of the output terminals of the source driver 20 can be reduced without increasing the number of the scanning lines. The connection-pitch width of the LSI constituting the source driver 20 can therefore be decreased. This renders it easy to connect this LSI to the display unit 10. Further, the LSI can be made small because the source driver 20 has fewer output terminals than otherwise.

In the pixel-connection configuration of FIG. 2, any adjacent pixels BlueN and RedN can be switched in position. If they are switched in position, the order in which to input the red-display data and the blue-display data to the source driver 20 must be reversed.

Moreover, any green-display pixel GreenN for performing green display does not share a signal line with any blue-display pixel BlueN or any red-display pixel RedN. The time of writing the gradation voltage in any green-display pixel Green can therefore be one horizontal period (1H) and accomplish more appropriate gradation display than the blue-display pixels and red-display pixels. This is because the human eye perceives green better than any other color. Hence, the image displayed can have relatively high quality even if the red gradation display and blue gradation display are relatively poor, so long as the blue gradation display is appropriate.

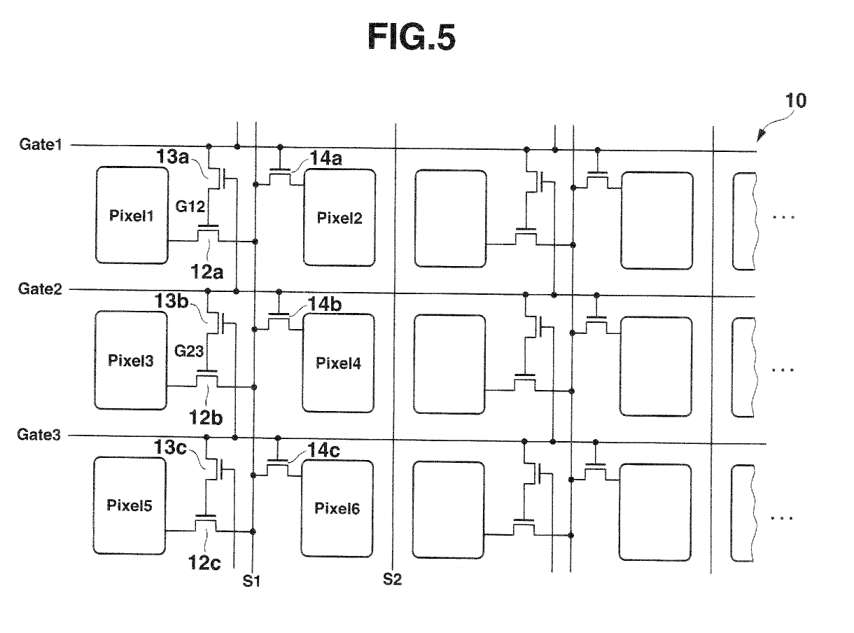

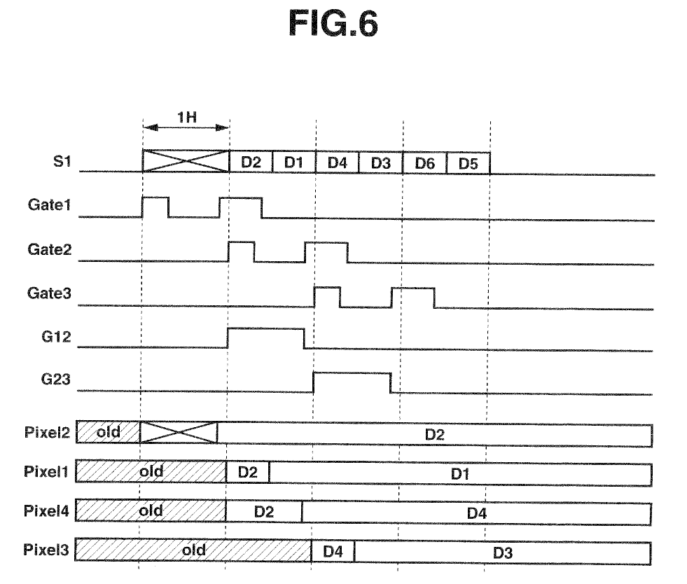

If color is not taken into account, any two adjacent pixels arranged along a scanning line can be connected one signal line as shown in FIG. 5. In this case, the number of signal lines required can be reduced to half (½) the number of pixels constituting one row. That is, the number of signal lines can be further decreased. Note that a liquid crystal display apparatus operates as shown in the timing chart of FIG. 6. In FIG. 6, Pixel1, Pixel3 and Pixel5 are equivalent to pixels Blue1, Blue2 and Blue3 (FIG. 4), respectively, and Pixel2, Pixel4 and Pixel5 are equivalent to pixels Red1, Red2 and Red3 (FIG. 4), respectively. The control of scanning lines Gate1, Gate2 and Gate3, which is shown in FIG. 6, is basically the same as the control illustrated in FIG. 4.

### Second Embodiment

A second embodiment of this invention will be described. The second embodiment differs from the first embodiment in the connection of pixels and the operation of the display apparatus. The display apparatus is similar in basic configuration to the display apparatus according to the first embodiment, which is shown in FIG. 1. Therefore, the configuration of the second embodiment will not be described.

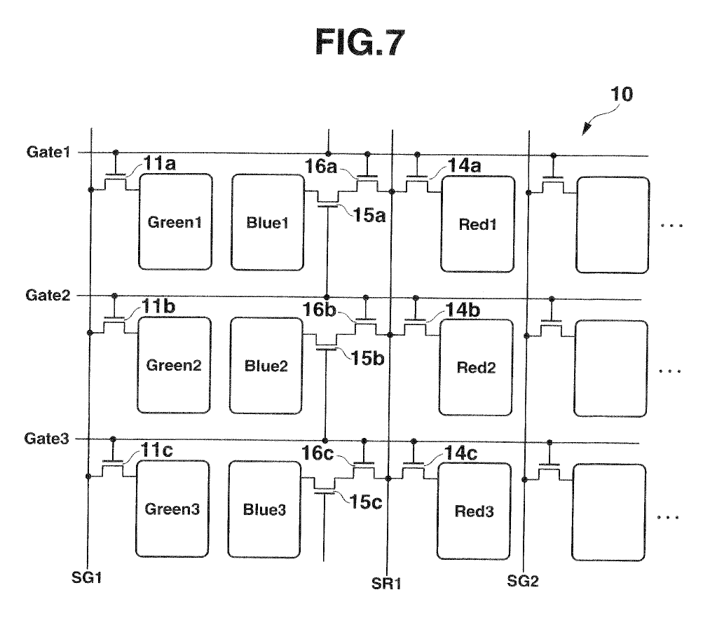

FIG. 7 is a diagram depicting the connection of the pixels in this embodiment. In FIG. 7, the connection of only nine of the pixels provided in the display unit 10 is as is shown in FIG. 2.

In this embodiment, the scanning lines Gate1, Gate2 and Gate3 are arranged, intersecting at right angles with the signal lines SG1, SR1 and SG2.

At the interactions of the scanning lines Gate1, Gate2 and Gate3 and the signal lines SG1, pixels Green1, Green2 and Green3 are arranged.

The pixels Green1, Green2 and Green3 (third pixels) are connected to the scanning lines Gate1, Gate2, Gate3, and the signal line SG1 by TFTs 11a, 11b and 11c (fourth switching elements), respectively. More specifically, the pixels Green1, Green2 and Green3 are connected to the drain electrodes (or source electrodes) of the TFTs 11a, 11b and 11c, respectively. The source electrodes (or drain electrodes) of the TFTs 11a, 11b and 11c are connected to the signal line SG1. Further, the gate electrodes of the TFTs 11a, 11b and 11c are connected to the scanning lines Gate1, Gate2 and Gate3, respectively.

Further, pixels Red1, Red2 and Red3 are arranged in the vicinity of the intersections of the scanning lines Gate1, Gate2 and Gate3 and the signal line SR1. Pixels Blue1, Blue2 and Blue 3 are arranged on one side of the signal line SR1, while the pixels Red1, Red2 and Red3 are arranged on the other side of the signal line SR1.

Pixels Blue1, Blue2 and Blue3 (second pixels) are connected to the scanning lines Gate1, Gate2, Gate3, and signal line SR1, respectively, by TFTs 15a, 15b and 15 (second switching elements) and TFTs 16a, 16b and 16c (third switching elements). More specifically, the pixels Blue1, Blue2 and Blue3 are connected to the drain electrodes (or source electrodes) of the TFTs 15a, 15b and 15c. The source electrodes (or drain electrodes) of the TFTs 15a, 15b and 15c are connected to the drain electrodes (or source electrodes) of the TFTs 16a, 16b and 16c. The gate electrodes of the TFTs 15a, 15b and 15c are connected to the lower (or second) of the two scanning lines between which the pixels are arranged. Further, the source electrodes (or drain electrodes) of the TFTs 16a, 16b and 16c are connected to the signal line SR1. The gate electrodes of the TFTs 16a, 16a and 16c are connected to the upper (or first) of the two scanning lines between which the pixels are arranged.

The pixels Red1, Red2 and Red3 (first pixels) are connected to the scanning lines Gate1, Gate2, Gate3, and signal line SR1, respectively, by TFTs 14a, 14b and 14c. More precisely, pixels Red1, Red2 and Red3 are connected to the drain electrodes (or source electrodes) of the TFTs 14a, 14b and 14c. The source electrodes (or drain electrodes) of the TFTs 14a, 14b and 14c are connected to the signal line SR1. The gate electrodes of the TFTs 14a, 14b and 14c are connected to the scanning lines Gate1, Gate2 and Gate3, respectively.

In this configuration, the gate driver 30 supplies scan signals to the scanning lines Gate1, Gate2 and Gate3. To the signal line SG1, the source driver 20 supplies a gradation signal pertaining to green display. Moreover, to the signal line SR1, the source driver 20 supplies gradation signals pertaining to red display and blue display, respectively, in a time-sharing fashion.

In the configuration of FIG. 7, too, the number of signal lines required can be reduced to two-thirds (⅔) of the number of pixels forming one row.

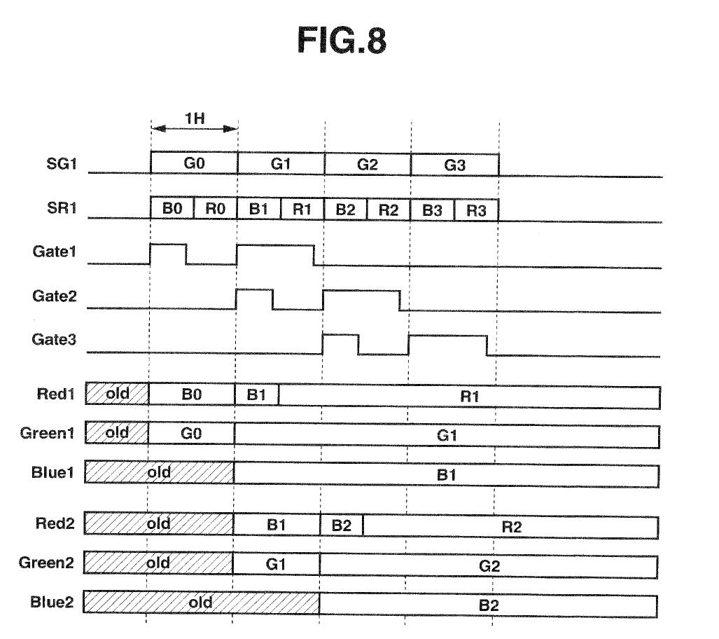

How a liquid crystal display apparatus according to the present embodiment operates will be explained with reference to the timing chart of FIG. 8. FIG. 8 shows the gradation signal supplied to the signal line SG1, the gradation signal supplied to the signal line SR1, the scan signal supplied to the scanning line Gate1, the scan signal supplied to the scanning line Gate2, the scan signal supplied to the scanning line Gate3, the display state of the pixel Red1, the display state of the pixel Green1, and the display state of the pixel Blue1, the display state of the pixel Red2, the display state of the pixel Green2, and the display state of the pixel Blue2, from top to bottom in the order mentioned.

In this embodiment, the display data pertaining to the green display is input to the source driver 20, at the same timing as the display data pertaining to the red or blue display. The display data items pertaining to the red display and blue display, respectively, are alternately input to the source driver 20, each during half (½) of the horizontal period. In the present embodiment, the display data pertaining to red display and the display data pertaining to blue display are input in the order reverse to the order shown in FIG. 4. Therefore, as shown in FIG. 8, gradation signals B0, R0, B1, R1, B2, R2, . . . , which pertain to Red display and blue display are supplied to the signal line SR1 at the timing the gradation signals G0, G1, G2, . . . which pertain to green display are supplied to the signal line SG1.

The following explanation is concerned also with the display performed by only pixels Green1, Blue1 and Red1 connected to the scanning line Gate1 and pixels Green2, Blue2 and Red2 connected to the scanning line Gate2. The pixels of any other rows are controlled in the same way as the pixels Green1, Blue1, Red1, Green2, Blue2 and Red2.

To cause the pixels Green1, Blue1 and Red1 to perform display, the scan signals on the scanning lines Gate1 and Gate2 are first maintained High for prescribed periods, respectively. The period for which the scan signal on the scanning line Gate1 remains High is longer than the period for which the scan signal on the scanning line Gate2 remains High. In the case of FIG. 8, the period for which the scan signal on the scanning line Gate1 remains High is one horizontal period, while the period for which the scan signal on the scanning line Gate2 remains High is half (½) the horizontal period.

When the scan signal on the scanning line Gate1 is set to High, TFT 11a, TFT 14a and TFT 16a are turned on. The gradation signal G1 supplied to the signal line SG1 is thereby written in the pixel Green1. The pixel Green1 therefore starts performing display in response to the gradation signal G1. The gradation signal B1 supplied to the signal line SR1 is written in the pixel Red1. The pixel Red1 therefore starts performing display in response to the gradation signal B1.

When the scan signal on the scanning line Gate2 is set to High, TFT 11b, TFT 14b and TFT 15a are turned on. The gradation signal G1 supplied to the signal line SG1 is thereby written in the pixel Green2. The pixel Green2 therefore starts performing display in response to the gradation signal G1. At the same time, the gradation signal B1 supplied to the signal line SR1 is written in the pixel Red2. The pixel Red2 therefore starts performing display in response to the gradation signal B1. Further, the gradation signal B1 supplied to the signal line SR1 is written in the pixel Blue1. The pixel Blue1 starts performing display in response to the gradation signal B1.

After the scan signal on the scanning line Gate2 has fallen to Low, the pixel voltages Vlcd generated in the pixels Blue1, Green2 and Red2, respectively, are held in the compensation capacitors Cs that the pixels Blue1, Green2 and Red2 have, until the scan signal on the scanning line Gate2 is set to High again. The scan signal on the scanning line Gate1 remains High even after the scan signal on the scanning line Gate2 has fallen to Low. The gradation signal R1 supplied to the signal line SR1 is therefore written anew in the pixel Red1. The pixel Red1 starts performing display in response to the gradation signal R1.

After the scan signal on the scanning line Gate1 has fallen to Low, the pixel voltages Vlcd generated in the pixels Green1 and Red1 are held in the compensation capacitors Cs that the pixels Greed1 and Red1 have, respectively, until the scan signal on the scanning line Gate1 is set to High again. Thus, the pixels R1, G1 and B1 perform appropriate gradation display based on the video signal.

In the next horizontal period, the scan signals on the scanning lines Gate2 and Gate3 are set to High, each for the prescribed time, in order to drive the pixels Green2, Blue2 and Red3. In the case of FIG. 8, the scan signal on the scanning line Gate2 is held High for one horizontal period, whereas the scan signal on the scanning line Gate3 is held High for half (½) the horizontal period.

When the scan signal on the scanning line Gate2 is set to High as described above, TFT 11b, TFT 14b and TFT 15a are turned on. As a result, the gradation signal G2 supplied to the signal line SG1 is written in the pixel Green2, which performs display in response to the gradation signal G2. Further, the gradation signal B2 supplied to the signal line SR1 is written in the pixel Red2, which performs display in response to the gradation signal B2. Although TFT 15a has been turned on, TFT 16a is off. No gradation voltage is therefore written in the pixel Blue1.

When the scan signal on the scanning line Gate3 is set to High, TFT 11c, TFT 14c and TFT 15b are turned on. The gradation signal G2 supplied to the signal line SG1 is written in the pixel Green3, which performs display in response to the gradation signal G2. Further, the gradation signal B2 supplied to the signal line SR1 is written in the pixel Red3. The pixel Red3 performs display in response to the gradation signal B2. Moreover, the gradation signal B2 supplied to the signal line SR1 is written in the pixel Blue2. The pixel Blue2 therefore starts performing display in response to the gradation signal B2.

After the scan signal on the scanning line Gate3 has fallen to Low, the pixel voltages Vlcd generated in the pixels Blue2, Green3 and Red3 are held in the compensation capacitors Cs that the pixels Blue2, Green3 and Red3 have, until the scan signal on the scanning line Gate3 is set to High again. Even after the scan signal on the scanning line Gate3 has fallen to Low, the scan signal on the scanning line Gate2 remains High. The gradation signal R2 supplied to the signal line SR1 is therefore written anew in the pixel Red2. The pixel Red2 starts performing display in response to the gradation signal R2.

After the scan signal on the scanning line Gate2 has fallen to Low, the pixel voltages Vlcd generated in the pixels Green2 and Red2 are held in the compensation capacitors Cs that the pixels Green2 and Red2 have, until the scan signal on the scanning line Gate2 is set to High again. Thus, the pixels R2, G2 and B2 perform appropriate gradation display based on the video signal.

The same control as described above is performed on the rows following the scanning line Gate3. The pixels of these rows also perform appropriate gradation display based on the video signal.

The second embodiment configured as described above can achieve the same advantage as the first embodiment. In the first embodiment, the gradation voltage may not be fully written in any pixel BlueN, depending on the state in which the TFT 12a holds gate potential G12 or the state in which the TFT 12b holds gate potential G23, because the gradation voltage is written in the pixel BlueN while maintaining the gate potential G12 or gate potential G23 in High state in the second embodiment, each TFT can be reliably turned on, and the gradation voltage can therefore be written in each pixel more reliably than in the first embodiment.

In the pixel-connection configuration of FIG. 7, any adjacent pixel BlueN and RedN can be switched in position. If they are switched in position, the order in which to input the red-display data and the blue-display data to the source driver 20 must be reversed.

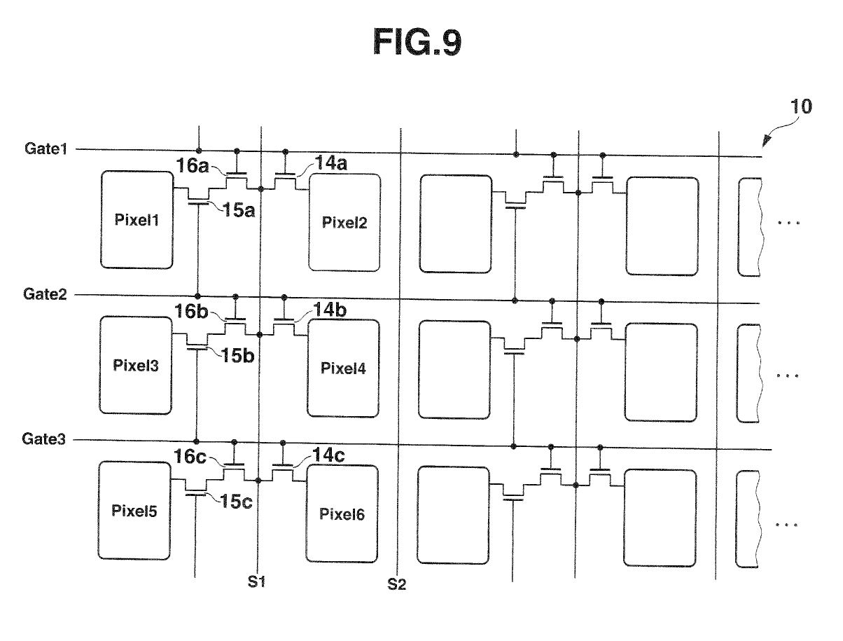

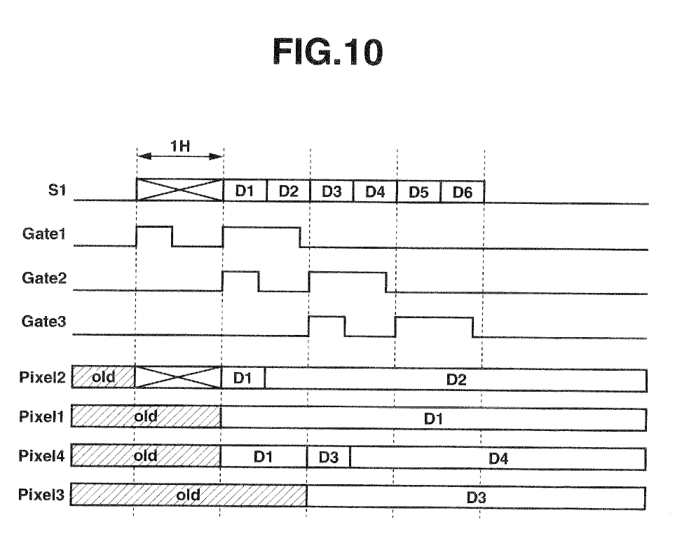

Moreover, any green-display pixel GreenN for performing green display does not share a signal line with any other green-display pixel, for the same reason as in the first embodiment. Hence, if color is riot taken into account, any two adjacent pixels arranged along a scanning line can be connected to one signal line as shown in FIG. 9. In this case, the number of signal lines required can be reduced to half (½) the number of pixels constituting one row. Note that a liquid crystal display apparatus having pixels arranged as shown in FIG. 9 operates as shown in the Liming chart of FIG. 10. In FIG. 10, Pixel1, Pixel3 and Pixels are equivalent to pixels Blue1, Blue2 and Blue3, respectively, and Pixel2, Pixel4 and Pixel6 are equivalent to pixels Red1, Red2 and Red3, respectively. The control of scanning lines Gate1, Gate2 and Gate3, which is shown in FIG. 10 is basically the same as the control illustrated in FIG. 8.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display apparatus comprising:
a plurality of scanning lines;
a plurality of signal lines arranged, intersecting at right angles with the scanning lines;
a plurality of first pixels arranged between first and second scanning lines adjacent to each other, and arranged near at least some of the signal lines;
a plurality of second pixels arranged, some on one side of the signal line arranged near the first pixels, and the others on the other side of the signal line;
a plurality of first switching elements connected to the first pixels, to the signal line near the first pixels and to the first scanning line;
a plurality of second switching elements connected to the second pixels and to the signal line near the first pixels; and
a plurality of third switching elements connected to the second switching elements, to the first scanning line and to the second scanning line.

2. The display apparatus according to claim 1, further comprising:
a signal-line drive circuit configured to supply a gradation signal corresponding to the first pixels, to the signal line near the first pixels in order to set the first pixels in a display state, and to supply a gradation signal corresponding to the second pixels, to the signal line near the second pixels in order to set the second pixels in the display state; and
a scanning-line drive circuit configured to supply a scan signal to the first scanning line while the gradation signal corresponding to the first pixels is being supplied to the signal line near the first pixels, and to supply a scan signal to the second scanning line, until the supply of the scan signal to the first scanning line is almost terminated,
wherein the first switching elements set the first pixels to the display state when the scan signal is supplied to the first scanning line; the third switching elements output to the second switching elements a scan signal supplied to the first scanning line while the scan signal is supplied to the first and second scanning lines; and the second switching elements receives the scan signal from the third switching elements, setting the second pixels to the display state.

3. The display apparatus according to claim 1, further comprising:
a plurality of third pixels arranged between the first and second scanning lines and near a signal line other than the signal line arranged near the first pixels; and
a plurality of fourth switching elements connected to the third pixels, to the signal line near the first pixels and to the first scanning line.

4. The display apparatus according to claim 3, wherein the first pixels are pixels configured to perform one of two color display modes consisting of red display and blue display, the second pixels are pixels configured to perform the other of the two color display modes, and the third pixels are configured to perform green display.

5. The display apparatus according to claim 1, wherein the first switching elements are thin film transistors, each having a gate electrode which is connected to the first scanning line, and having a source electrode and a drain electrode, one of which is connected to a signal line and the other of which is connected to a first pixel; the second switching elements are thin film transistors, each having a source electrode and a drain electrode, one of which is connected to a signal line and the other of which is connected to a second pixel; and the third switching elements are thin film transistors, each having a source electrode and a drain electrode, one of which is connected to the first scanning line and the other of which is connected to the gate electrode of one second switching element.

6. A display apparatus comprising:
a first pixel and a second pixel arranged adjacent to each other, respectively on one side of a first signal line and the other side therefore;
a first scanning line and a second scanning line arranged, respectively on one side of the first and second pixels and on the other side thereof;
a first thin film transistor having a gate electrode connected to the first scanning line, and having a source electrode and a drain electrode, one of which is connected to the first signal line and the other of which is connected to the first pixel;
a second thin film transistor having a source electrode, and having a drain electrode, one of which is connected to the first signal line and the other of which is connected to the second pixel; and
a third thin film transistor having a gate electrode connected to the second scanning line, and having a source electrode and a drain electrode, one of which is connected to the first scanning line and the other of which is connected to the gate electrode of the second thin film transistor

7. The display apparatus according to claim 6, further comprising a signal-line drive circuit configured to supply, in a time-sharing fashion, to the first signal line a voltage to be held in the first pixel and a voltage to be held in the second pixel.

8. The display apparatus according to claim 6, further comprising:
a third pixel arranged adjacent to the first pixel, the third and first pixels being located respectively on one side of a second signal line and the other side therefore; and
a fourth thin film transistor having a gate electrode connected to the first scanning line, and having a source electrode and a drain electrode, one of which is connected to the second signal line and the other of which is connected to the third pixel.

9. The display apparatus according to claim 8, wherein the one of the first and second pixels corresponds to a red component, the other of the first and second pixels corresponds to a blue component, and the third pixel corresponds to a green component.

10. The display apparatus according to claim 6, further comprising:
a third pixel arranged near the second pixel and on a side other than the side of the first pixel;
a second signal line arranged near the third pixel and on a side other than the side of the second pixel; arid
a fourth thin film transistor having a gate electrode connected to the first scanning line, and having a source electrode and a drain electrode, one of which is connected to the second signal line and the other of which is connected to the third pixel.

11. The display apparatus according to claim 10, wherein one of the first and second pixels corresponds to a red component, the other of the first and second pixels corresponds to a blue component, and the third pixel corresponds to a green component.

12. A display apparatus comprising:
a first pixel and a second pixel arranged adjacent to each other, respectively on one side of a first signal line and the other side therefore;
a first scanning line and second scanning line arranged, respectively on one side of the first and second pixels and the other side thereof;
a first thin film transistor having a gate electrode connected to the first scanning line, and having a source electrode and a drain electrode, one of which is connected to the first scanning line and the other of which is connected to the first pixel;
a second thin film transistor having a source electrode and a drain electrode, one of which is connected to the second signal line; and
a third thin film transistor having a gate electrode connected to the first scanning line, and having a source electrode and a drain electrode, one of which is connected to the first signal line and the other of which is connected to the other of the source and drain electrodes of the second thin film transistor;
a third pixel arranged near the first pixel and on a side other than the side of the first pixel; and
a fourth thin film transistor having a gate electrode connected to the first scanning line, and having a source electrode and a drain electrode, one of which is connected to the second signal line and the other of which is connected to the third pixel.

13. The display apparatus according to claim 12, further comprising a signal-line drive circuit configured to supply to the first signal line, in time sharing fashion, a voltage to be held in the first pixel and a voltage to be held in the second pixel.

14. The display apparatus according to claim 12, wherein one of the first and second pixels corresponds to a red component, the other of the first and second pixels corresponds to a blue component, and the third pixel corresponds to a green component.

15. A display apparatus having a plurality of pixel columns corresponding to a green component, a plurality of pixel columns corresponding to a blue component and a plurality of pixel columns corresponding to a red component, the pixels of the green component, blue component and red component being alternately arranged in rows in the order mentioned, or pixels of the green component, red component and blue component being alternately arranged in rows in the order mentioned, the display apparatus comprising:
first signal lines electrically connected to the pixel columns corresponding to green component, respectively; and
second signal lines, each electrically connected to two adjacent pixel columns one of which corresponds to red the component and the other of which corresponds to the blue component

16. The display apparatus according to claim 15, further comprising a signal-line drive circuit configured to supply, in a time-sharing fashion, to the second signal lines a voltage to be held in the pixel columns corresponding to the red component and a voltage to be held in the pixel columns corresponding to the blue component.

17. The display apparatus according to claim 15, wherein each pixel column corresponding to the green component and each pixel column corresponding to the blue component, or each pixel column corresponding to the green component and each pixel column corresponding to the red component are arranged between one first signal line and one second signal line.

18. The display apparatus according to claim 15, wherein each pixel column corresponding to the green component and each pixel column corresponding to the red component are arranged, respectively on one side of one second signal line and on the other side thereof.

19. The display apparatus according to claim 15, wherein each pixel of any pixel column corresponding to the blue component is connected to a scanning line by a number of thin film transistors, and the pixel of a pixel column corresponding to the red component which is adjacent to the pixel of the corresponding to the blue component is connected to the same scanning line by a different number of thin film transistors.
